(19) United States
(12) Patent Application Publication
(10) Pub. No.: US 2010/0097937 A1
(43) Pub. Date: Apr. 22, 2010

(54) METHOD AND APPARATUS FOR WIRELESS TRANSMIT/RECEIVE UNIT SPECIFIC PILOT SIGNAL TRANSMISSION AND WIRELESS TRANSMIT/RECEIVE UNIT SPECIFIC PILOT SIGNAL POWER BOOSTING

(75) Inventors: Philip J. Pietraski, Huntington Station, NY (US); Sung-Hyuk Shin, Northvale, NJ (US); Erdem Bala, Farmingdale, NY (US); Guodong Zhang, Syosset, NY (US); Kyle Jung-Lin Pan, Smithtown, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/578,131

(22) Filed: Oct. 13, 2009

Related U.S. Application Data
(60) Provisional application No. 61/105,971, filed on Oct. 16, 2008.

(51) Int. Cl. H04W 24/00; H04W 72/04

(52) U.S. Cl. 370/241; 370/330

(57) ABSTRACT

A method and apparatus are described for providing improved channel estimation for wireless transmit/receive units (WTRUs) that require improved channel estimation (e.g., cell edge WTRUs) by allocating additional resource elements (REs) as pilot signals to improve channel estimation. These additional REs may be allocated to be used with expanded reference signals (ERSs).

### CROSS REFERENCE TO RELATED APPLICATIONS

This application claims the benefit of U.S. Provisional Application No. 61/105,971 filed Oct. 16, 2008, which is incorporated by reference as if fully set forth.

### TECHNICAL FIELD

This application is related to wireless communications.

### BACKGROUND

A long term evolution (LTE) downlink (DL) waveform is an orthogonal frequency division multiple access (OFDMA) signal consisting of a set of resource elements (REs) defined by specific time and frequency grids formed by orthogonal frequency division multiplexing (OFDM) symbols in time and subcarriers in frequency. The REs are arranged into resource blocks (RBs). Each RB includes common reference signal (CRS) REs that constitute pilot signals. The CRS REs are transmitted with the same power throughout the configured system bandwidth since they are common and must be available to all wireless transmit/receive units (WTRUs) for performing channel estimation.

FIG. 1 shows the placement of CRSs for LTE R8 for up to four (4) transmit (Tx) antennas. For multi-antenna transmissions not using beamforming, the pilots from each antenna must be distinguishable so that per-antenna channel estimation can be performed. To this end, the pilots are made essentially orthogonal by arranging them in different time/frequency resource elements as depicted in FIG. 1. Intra-cell interference can be nearly eliminated by using combined frequency division multiplexing (FDM) and time division multiplexing (TDM) for a pilot signal or a CRS.

It has been observed that optimum pilot/data power ratio is fixed throughout the cell. However, there is limited ability to appropriately change the ratio since the CRS cannot be changed on a per WTRU basis. The ratio of physical downlink shared channel (PDSCH) energy per RE (EPRE) to cell-specific reference signal (RS) EPRE among PDSCH REs (not applicable to PDSCH REs with zero EPRE) for each OFDM symbol is denoted by either ρ_{A} and ρ_{B} according to the OFDM symbol index. In addition, ρ_{A} and ρ_{B} are WTRU-specific. ρ_{A} is determined by using a WTRU-specific parameter P_{A} signaled by higher layers, and ρ_{B}/ρ_{A} is a cell specific ratio according to cell specific parameter P_{B} signaled by higher layers and the number of configured eNodeB cell specific antenna ports. The PDSCH/cell specific RS power ratio is determined by the signaled parameters P_{A} and P_{B}, but this is insufficient because the only mechanism available to increase or decrease the PDSCH/RS ratio is to raise or lower the data power relative to the fixed pilot power which is just the opposite of what has been referred to as “RS power boosting” to improve cell edge performance.

A method and apparatus for WTRU-specific pilot signal transmission and WTRU-specific pilot signal power boosting is desired.

### SUMMARY

A method and apparatus for WTRU-specific pilot signal transmission and WTRU-specific pilot signal power boosting for a LTE/LTE-advanced (LTE-A) downlink and uplink is disclosed. The method and apparatus improve pilot signal transmission and pilot signal power boosting by enhancing channel estimation for WTRUs that require it, (e.g., cell edge WTRUs) through the allocation of additional REs as pilot signals. The method and apparatus also include the sending of additional ERSs and puncturing the REs used for the physical downlink control channel (PDCCH) or the PDSCH of a specific WTRU.

### BRIEF DESCRIPTION OF THE DRAWINGS

A more detailed understanding may be had from the following description, given by way of example in conjunction with the accompanying drawings wherein:

FIG. 1 is an arrangement of common pilot signals in LTE R8;

FIG. 2 shows a sample pattern for WTRU-specific reference signals having up to 4 layers;

FIG. 3 shows an example of a block diagram of an eNodeB; and

FIG. 4 shows an example of a block diagram of a WTRU.

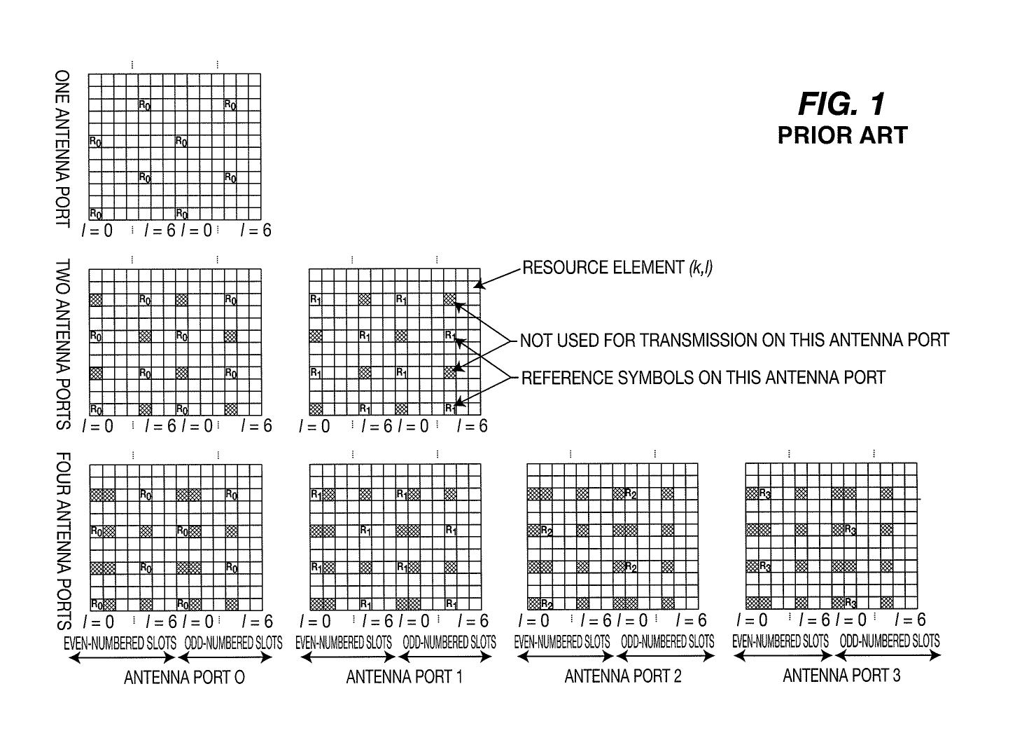

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment.

When referred to hereafter, the terminology “evolved Node-B (eNodeB)” includes but is not limited to a base station, a site controller, an access point (AP), or any other type of interfacing device capable of operating in a wireless environment.

A mechanism is provided for WTRUs that require improved channel estimation, (e.g., cell edge WTRUs), whereby additional REs are allocated as WTRU-specific reference signals/pilots. These additional REs can be defined as expanded reference signals (ERS). In R8, WTRU-specific RSs are used only for a single transmission mode (mode 7) and support only one layer of data transmission (single layer beamforming). These pilots are dedicated reference signals (DRSs) and are transmitted over port 5, (and beamformed in the same way as the data). For simplicity, some or all of the REs defined as WTRU specific RSs in R8 can be used as ERSs.

In R8, data demodulation is achieved with common RSs. In R10 and in further releases, data demodulation may be achieved with WTRU-specific RSs, not for a single transmission mode, but for all MIMO transmission modes and any other type of transmission mode. These new WTRU-specific RSs (i.e., ERSs) may be transmitted alone, or in addition to the CRSs, and may be precoded in the same way as the PDSCH, or not precoded at all.

Expanded reference signals (ERSs) are arranged to ensure time-frequency and/or spreading code division. The power level for the ERSs does not need to be the same power as the CRSs, since they will not be used by other WTRUs. The power of the ERSs may be determined by P_{A} and/or P_{B}, or other new fixed, cell-specific, or WTRU-specific parameters. The number, transmit power, and time-frequency locations of the ERSs may be fixed or signaled by broadcast, layer 2 (L2)/layer 3 (L3) signaling, layer 1 (L1) signaling or combinations thereof. For example, the possible locations of ERS are either fixed or can be updated semi-statically via broadcast channel.

The number of REs allocated to be used as WTRU-specific ERSs is either fixed depending on the transmission parameters, (e.g., MIMO mode/rank), or is part of radio resource control (RRC) signaling. The power level may be a function of P_{A}, (e.g., P_{A}+P_{E}, where P_{E} is a WTRU or cell specific parameter, which can be signaled by RRC signaling). Note that possible values for P_{E} may be defined as negative infinity (−INF), 0, 3, or 6 dB, in which −INF may imply that ERS is “off” and the REs are not designated for ERS. Other values for P_{E} may also be used if desired for the designs.

The possible locations and the number of REs allocated for the use of ERSs may be determined based on the geometry, (or target quality of service (QoS)), of the WTRU, (or a group of WTRUs). Thus, for high geometry WTRUs with high signal-to-interference and noise ratio (SINR), a small number of REs may be allocated for the ERSs, while for low geometry WTRUs with a low SINR, more REs may be allocated for the ERSs.

The configuration for ERS may be a function of the allocated bandwidth (BW), (e.g., number of REs), and/or the multiple-input multiple-output (MIMO) configuration, such as the number of layers (or streams), rank, MIMO mode or cooperation mode used for the WTRU. As an example, more REs can be used as WTRU-specific ERSs when a MIMO transmission with a higher rank takes place, and a smaller number of REs may be used as WTRU-specific ERSs when MIMO transmission with a lower rank takes place. The ERSs configured for the demodulation of different data streams (layers) should be orthogonal to each other. The orthogonality may be achieved by transmitting these ERSs on different REs through the use of time and/or frequency multiplexing, by transmitting these ERSs on the same REs through the use of code division multiplexing, or by using a combination of these techniques.

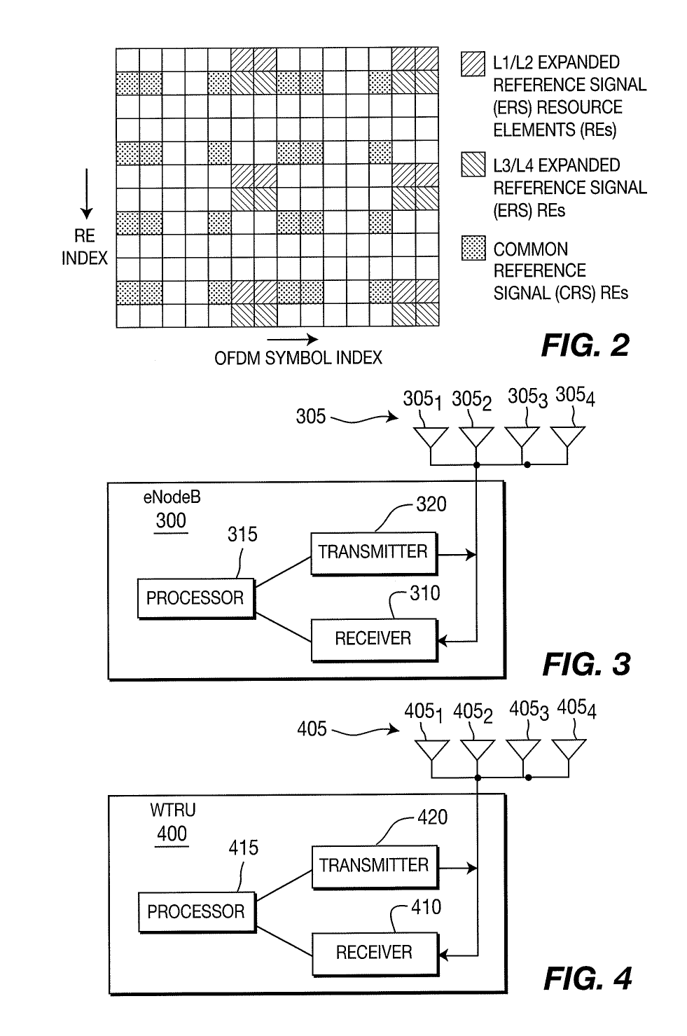

A sample configuration is illustrated in FIG. 2 where an ERS pattern for up to 4 layers is shown. The ERSs configured for layers 1 and 2 are multiplexed with code division multiplexing, (by spreading the ERSs for the two layers over two REs with orthogonal spreading codes), as well as the ERSs for layers 3 and 4. Different REs are used for the ERSs of the two pairs, i.e. layers 1-2 and layers 3-4. In FIG. 2, a total of 24 REs are shown that are used to carry the ERSs; 12 REs for layers 1 and 2, and 12 REs for layers 3 and 4. A different ERS configuration may be used for a different number of layers. For example, for up to 2 layers, only 12 REs may be used to carry the two ERSs.

Another method to send ERSs is to puncture the REs used for the PDCCH of a specific WTRU. In this case, the puncturing pattern is known to the WTRU so that the WTRU can ignore these REs while trying to decode the control channel data. Only the control channels of WTRUs that need additional ERSs are punctured. These WTRUs will ignore the REs used as ERSs, and decode the control data by using the remaining REs in the control channel. This is transparent to the other WTRUs because a control channel, (regardless of being punctured or not), used for a WTRU cannot be decoded by the remaining WTRUs. The number, transmit power, and time-frequency locations of the ERS can be signaled by broadcast, L2/3 signaling, or combinations of them.

Thus, reference signals may be transmitted on the REs used for a PDSCH or a PDCCH, whereby the WTRU knows the location of the reference signals in the subframe, so that it may detect the reference signals and estimate the channel. If the reference signals are precoded, the received signal on an RE allocated for ERS and for a given receive antenna can be written as:

r=hws+n, Equation (1)

where h is the channel vector between the receive antenna and the transmit antennas at the eNodeB, w is the precoding vector that multiplies the known pilot s, and n is additive noise. In this case, the WTRU can estimate the effective channel hw by using the ERS.

As an alternative to explicitly signaling the number and location of ERSs, the use of ERSs may be implied from operation mode and/or other signaling already used. For example, ERSs are always used when transmission time interval (TTI) bundling is used, or based on a CQI, e.g., when the last N reported channel quality indicator (CQI) is below a threshold, the eNodeB increases the use of ERSs. When the last M reported CQI is above another threshold, the eNodeB decreases the use of ERSs.

The definition of a CQI also needs to be agreed on between the eNodeB and the WTRU. There are several possibilities:
1) The reported CQI is based on the assumption that ERSs are not present;
2) The reported CQI is based on the assumption that all ERSs are present;
3) The reported CQI is based on the assumption that the last configured ERSs are present; and
4) The reported CQI is based on the assumption that the ERSs last used are present.
   Note that WTRU-specific ERSs may be used to compute a CQI value.

The multiplexing and mapping of physical downlink shared channel (PDSCH) data in TTI with ERSs may be appropriately performed with the knowledge of the presence and location of the ERSs. One way is to multiplex and map the data around the ERSs. This method can be used when the presence and/or location of the reference signals are known to the WTRU. The WTRU will not assume that data exists on the REs that are used to carry the reference signals. Alternatively, the data may be multiplexed and mapped to the REs as if WTRU-specific ERSs were not present in the TTI. Then, the ERSs may be used to puncture (replace) the data in pre-determined ERS REs. This method can be used when presence and/or location of the reference signals are not known to the WTRU. In this case, the WTRU will assume that data exists on the REs that are used to carry the reference signals.

The ERSs may also be configured more globally, across all or part of the system BW in a semi-static way with the locations of the ERSs possibly included in a broadcast and/or L2/3 signaling. Alternatively, the location and configuration of the ERSs may be standardized and be fixed at all times as is done with the CRSs in R8. In this way, the ERSs may be used more widely and by all WTRUs on a consistent basis.

FIG. 3 is an example of a block diagram of an eNodeB 300. The eNodeB 300 includes a MIMO antenna 305, a receiver 310, a processor 315 and a transmitter 320. The MIMO antenna 305 includes antenna elements 305₁, 305₂, 305₃ and 305₄. Although there are only four (4) antenna elements depicted in FIG. 3, an extension to eight or more antenna elements may be implemented and should be apparent to those skilled in the art.

For the downlink, the processor 315 in the eNodeB 300 is configured to generate the WTRU-specific reference signals and map them to the REs that are allocated to carry the reference signals. The processor may also precode the WTRU-specific reference signals. The transmitter 320 in the eNodeB 300 is configured to transmit an OFDMA signal including a plurality of time/frequency REs constituting a PDCCH or a PDCCH, wherein a portion of the REs are allocated to carry the precoded WTRU-specific reference signals.

For the uplink, the receiver 310 in the eNodeB 300 is configured to receive an OFDMA signal from at least one WTRU including a plurality of time/frequency REs constituting a physical uplink shared channel (PUSCH) or a physical uplink control channel (PUCCH), wherein a portion of the REs are allocated to carry WTRU-specific reference signals which may also be precoded. The processor 315 in the eNodeB 300 may be configured to perform a channel estimation based on the WTRU-specific reference signals.

FIG. 4 is an example of a block diagram of a WTRU 400. The WTRU 400 includes a MIMO antenna 405, a receiver 410, a processor 415 and a transmitter 420. The MIMO antenna 405 includes antenna elements 405₁, 405₂, 405₃ and 405₄. Although there are only four (4) antenna elements depicted in FIG. 4, an extension to eight or more antenna elements may be implemented and should be apparent to those skilled in the art.

For the downlink, the receiver 410 in the WTRU 400 is configured to receive an OFDMA signal from the eNodeB 300 including a plurality of time/frequency REs constituting a PDSCH, wherein a portion of the REs are allocated to carry the WTRU-specific reference signals which may have been precoded. The processor 415 in the WTRU 400 is configured to perform a channel estimation based on the WTRU-specific reference signals.

For the uplink, the processor 415 in the WTRU 400 is configured to precode WTRU-specific reference signals, and the transmitter 420 in the WTRU 400 may be configured to transmit an OFDMA signal including a plurality of time/frequency REs constituting a PUCCH, wherein a portion of the REs are allocated to carry the precoded WTRU-specific reference signals which may have been precoded.

Locations and quantity of REs allocated for the use of the WTRU-specific reference signals may be determined based on a condition that the WTRU has a high SINR or a low SINR. Locations and quantity of REs allocated for the use of the WTRU-specific reference signals may also be determined based on allocated bandwidth, MIMO configuration, layers or streams used, rank, MIMO mode or cooperation mode used.

The WTRU-specific reference signals may be configured in a pattern for multiple layers. WTRU-specific reference signals configured for particular ones of the layers may be multiplexed using at least one of time division multiplexing, frequency division multiplexing or code division multiplexing.

The WTRU-specific reference signals configured for demodulation of different data streams or layers may be orthogonal to each other.

The WTRU-specific reference signals may be used to compute CQIs. The WTRU may base the CQIs on the presence of the WTRU-specific reference signals known to the WTRU.

PDSCH data in a TTI may be multiplexed and mapped around the portion of REs allocated to carry the WTRU-specific reference signals.

PDSCH data in a TTI may be multiplexed and mapped to the REs allocated to carry the reference signals. Then, the REs are punctured and the data in the REs is replaced with the reference signals.

The receiver 410 in the WTRU 400 is configured to receive an OFDMA signal from the eNodeB 300 including a plurality of time/frequency REs constituting a PDCCH wherein a portion of the REs are allocated to carry the WTRU-specific reference signals which may have been precoded. The processor 415 in the WTRU 400 may be configured to puncture particular ones of the REs of the PDCCH on a condition that additional WTRU-specific reference signals are required by the PDSCH or PDCCH, wherein the WTRU ignores the REs allocated to carry the WTRU-specific reference signals, and decodes the control data by using the remaining REs in the PDCCH.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, application specific integrated circuits (ASICs), application specific standard products (ASSPs), field programmable gate arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, mobility management entity (MME) or evolved packet core (EPC), or any host computer. The WTRU may be used in conjunction with modules, implemented in hardware and/or software including a software defined radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a near field communication (NFC) module, a liquid crystal display (LCD) display unit, an organic light-emitting diode (OLED) display unit, a digital music player, a media player, a video game player module, an Internet browser, and/or any wireless local area network (WLAN) or ultra wide band (UWB) module.

What is claimed is:

1. A method, implemented by a wireless transmit/receive unit (WTRU), of processing specific reference signals, the method comprising:
receiving an orthogonal frequency division multiple access (OFDMA) signal including a plurality of time/frequency resource elements (REs) constituting a physical downlink shared channel (PDSCH), wherein a portion of the REs are allocated to carry WTRU-specific reference signals; and
performing a channel estimation based on the WTRU-specific reference signals.

2. The method of claim 1 wherein the WTRU-specific reference signals are precoded.

3. The method of claim 1 further comprising:
precoding WTRU-specific reference signals; and
transmitting an OFDMA signal including a plurality of REs constituting a physical uplink shared channel (PUSCH), wherein a portion of the REs are allocated to carry the precoded WTRU-specific reference signals.

4. The method of claim 1 wherein locations and quantity of REs allocated for the use of the WTRU-specific reference signals are determined based on a condition that the WTRU has a high signal-to-interference and noise ratio (SINR).

5. The method of claim 1 wherein locations and quantity of REs allocated for the use of the WTRU-specific reference signals are determined based on a condition that the WTRU has a low signal-to-interference and noise ratio (SINR).

6. The method of claim 1 wherein locations and quantity of REs allocated for the use of the WTRU-specific reference signals are determined based on allocated bandwidth.

7. The method of claim 1 wherein locations and quantity of REs allocated for the use of the WTRU-specific reference signals are determined based multiple-input multiple-output (MIMO) configuration.

8. The method of claim 1 wherein locations and quantity of REs allocated for the use of the WTRU-specific reference signals are determined based on layers or streams used.

9. The method of claim 1 wherein locations and quantity of REs allocated for the use of the WTRU-specific reference signals are determined based on rank, multiple-input multiple-output (MIMO) mode or cooperation mode used.

10. The method of claim 1 wherein the WTRU-specific reference signals are configured in a pattern for multiple layers.

11. The method of claim 10 wherein WTRU-specific reference signals configured for particular ones of the layers are multiplexed using at least one of time division multiplexing, frequency division multiplexing or code division multiplexing.

12. The method of claim 1 wherein the WTRU-specific reference signals configured for demodulation of different data streams or layers are orthogonal to each other.

13. The method of claim 1 further comprising:
using the WTRU-specific reference signals to compute channel quality indicators (CQIs).

14. The method of claim 13 wherein the WTRU bases the CQIs on the presence of the WTRU-specific reference signals known to the WTRU.

15. The method of claim 1 further comprising:
multiplexing and mapping PDSCH data in transmission timing intervals (TTIs) around the portion of REs allocated to carry the WTRU-specific reference signals.

16. The method of claim 1 further comprising:
multiplexing and mapping PDSCH data in transmission timing intervals (TTIs) to the REs allocated to carry reference signals;
puncturing the REs; and
replacing the data with reference signals.

17. A method, implemented by a wireless transmit/receive unit (WTRU), of processing specific reference signals, the method comprising:
receiving an orthogonal frequency division multiple access (OFDMA) signal including a plurality of time/frequency resource elements (REs) used for a physical downlink control channel (PDCCH), wherein a portion of the REs are allocated to carry WTRU-specific reference signals;
puncturing particular ones of the REs on a condition that additional WTRU-specific reference signals are required by the PDCCH, wherein the WTRU ignores the REs allocated to carry the WTRU-specific reference signals; and
decoding control data by using the remaining REs in the PDCCH.

18. The method of claim 17 wherein the WTRU-specific reference signals are precoded.

19. A wireless transmit/receive unit (WTRU) for processing specific reference signals, the WTRU comprising:
a receiver configured to receive an orthogonal frequency division multiple access (OFDMA) signal including a plurality of time/frequency resource elements (REs) constituting a physical downlink shared channel (PDSCH), wherein a portion of the REs are allocated to carry WTRU-specific reference signals; and
a processor configured to perform a channel estimation based on the WTRU-specific reference signals.

20. The WTRU of claim 19 wherein the WTRU-specific reference signals are precoded.

21. The WTRU of claim 19 wherein the processor is further configured to precode WTRU-specific reference signals, the WTRU further comprising:
a transmitter configured to transmit an OFDMA signal including a plurality of REs constituting a physical uplink shared channel (PUSCH), wherein a portion of the REs are allocated to carry the precoded WTRU-specific reference signals.

22. The WTRU of claim 19 wherein locations and quantity of REs allocated for the use of the WTRU-specific reference signals are determined based on a condition that the WTRU has a high signal-to-interference and noise ratio (SINR).

23. The WTRU of claim 19 wherein locations and quantity of REs allocated for the use of the WTRU-specific reference signals are determined based on a condition that the WTRU has a low signal-to-interference and noise ratio (SINR).

24. The WTRU of claim 19 wherein locations and quantity of REs allocated for the use of the WTRU-specific reference signals are determined based on allocated bandwidth.

25. The WTRU of claim 19 wherein locations and quantity of REs allocated for the use of the WTRU-specific reference signals are determined based multiple-input multiple-output (MIMO) configuration.

26. The WTRU of claim 19 wherein locations and quantity of REs allocated for the use of the WTRU-specific reference signals are determined based on layers or streams used.

27. The WTRU of claim 19 wherein locations and quantity of REs allocated for the use of the WTRU-specific reference signals are determined based on rank, multiple-input multiple-output (MIMO) mode or cooperation mode used.

28. The WTRU of claim 19 wherein the WTRU-specific reference signals are configured in a pattern for multiple layers.

29. The WTRU of claim 28 wherein WTRU-specific reference signals configured for particular ones of the layers are multiplexed using at least one of time division multiplexing, frequency division multiplexing or code division multiplexing.

30. The WTRU of claim 19 wherein the WTRU-specific reference signals configured for demodulation of different data streams or layers are orthogonal to each other.

31. The WTRU of claim 19 further wherein the WTRU-specific reference signals are used to compute channel quality indicators (CQIs).

32. The WTRU of claim 31 wherein the WTRU bases the CQIs on the presence of the WTRU-specific reference signals known to the WTRU.

33. The WTRU of claim 19 wherein PDSCH data in transmission timing intervals (TTIs) around the portion of REs allocated to carry the WTRU-specific reference signals is multiplexed and mapped.

34. The WTRU of claim 19 wherein the processor is further configured to multiplex and map PDSCH data in transmission timing intervals (TTIs) to the REs allocated to carry reference signals, puncture the REs and replace the data with reference signals.

35. A wireless transmit/receive unit (WTRU) for processing specific reference signals, the WTRU comprising:
a receiver configured to receive an orthogonal frequency division multiple access (OFDMA) signal including a plurality of time/frequency resource elements (REs) used for a physical downlink control channel (PDCCH), wherein a portion of the REs are allocated to carry WTRU-specific reference signals; and
a processor configured to puncture particular ones of the REs on a condition that additional WTRU-specific reference signals are required by the PDCCH, wherein the WTRU ignores the REs allocated to carry the WTRU-specific reference signals, and decodes control data by using the remaining REs in the PDCCH.
